(19) United States
(12) Patent Application Publication
(10) Pub. No.: US 2013/0074445 A1
(43) Pub. Date: Mar. 28, 2013

(54) VACUUM INSULATING GLASS (VIG) UNIT PUMP-OUT TUBE PROTECTING TECHNIQUES, AND/OR VIG UNITS INCORPORATING THE SAME

(71) Applicant: Jeffrey A. JONES, Ann Arbor, MI (US)

(72) Inventor: Jeffrey A. JONES, Ann Arbor, MI (US)

(73) Assignee: Guardian Industries Corp., Auburn Hills, MI (US)

(21) Appl. No.: 13/246,980

(22) Filed: Sep. 28, 2011

(51) Int. Cl. E06B 3/67; B32B 37/14; B32B 37/12; E06B 3/663; E06B 3/677

(52) U.S. Cl. 52/786.13; 52/788.1; 156/104

(57) ABSTRACT

Certain example embodiments of this invention relate to techniques for protecting the pump-out tubes of vacuum insulating glass (VIG) units. More particularly, certain example embodiments relate to techniques for protecting a pump-out tube of a VIG unit by providing a cap around the tube, with the cap and the tube being mechanically separated from one another. In certain example embodiments, the cap and an outer surface of the substrate in which the pump-out tube is located are connected to one another via an adhesive (e.g., a double-sided tape or other adhesive). The mechanical separation or isolation as between the cap and the tube may help protect the potentially fragile glass pump-out tube, in that forces imparted to the cap preferably would be buffered from and generally not transferred to the tube.

### FIELD OF THE INVENTION

Certain example embodiments of this invention relate to techniques for protecting the pump-out tubes of vacuum insulating glass (VIG) units. More particularly, certain example embodiments relate to techniques for protecting a pump-out tube of a VIG unit by providing a cap around the tube, with the cap and the tube being mechanically separated from one another. In certain example embodiments, the cap and an outer surface of the substrate in which the pump-out tube is located are connected to one another via an adhesive (e.g., a double-sided tape or other adhesive).

### BACKGROUND AND SUMMARY OF EXAMPLE EMBODIMENTS OF THE INVENTION

Vacuum IG units are known in the art. For example, see U.S. Pat. Nos. 5,664,395, 5,657,607, and 5,902,652, the disclosures of which are all hereby incorporated herein by reference.

FIGS. 1-2 illustrate a conventional vacuum IG unit (vacuum IG unit or VIG unit). Vacuum IG unit 1 includes two spaced apart glass substrates 2 and 3, which enclose an evacuated or low pressure space 6 therebetween. Glass sheets/substrates 2 and 3 are interconnected by peripheral or edge seal of fused solder glass 4 and an array of support pillars or spacers 5.

Pump out tube 8 is hermetically sealed by solder glass 9 to an aperture or hole 10 which passes from an interior surface of glass sheet 2 to the bottom of recess 11 in the exterior face of sheet 2. A vacuum is attached to pump out tube 8 so that the interior cavity between substrates 2 and 3 can be evacuated to create a low pressure area or space 6. After evacuation, tube 8 is melted to seal the vacuum. Recess 11 retains sealed tube 8. Optionally, a chemical getter 12 may be included within recess 13.

Conventional vacuum IG units, with their fused solder glass peripheral seals 4, have been manufactured as follows. Glass frit in a solution (ultimately to form solder glass edge seal 4) is initially deposited around the periphery of substrate 2. The other substrate 3 is brought down over top of substrate 2 so as to sandwich spacers 5 and the glass frit/solution therebetween. The entire assembly including sheets 2, 3, the spacers, and the seal material is then heated to a temperature of approximately 500° C., at which point the glass frit melts, wets the surfaces of the glass sheets 2, 3, and ultimately forms hermetic peripheral or edge seal 4. After formation of edge seal 4, a vacuum is drawn via the tube to form low pressure space 6.

The pressure in space 6 may be reduced by way of an evacuation process to a level below about 10⁻² Torr, more preferably below about 10⁻³ Torr, and most preferably below about 5×10⁻⁴ Torr. To maintain such low pressures below atmospheric pressure, substrates 2 and 3 are often hermetically sealed to one another by edge seal 4. The small, high strength support spacers 5 are provided between substrates 2, 3 in order to maintain separation of the approximately parallel substrates against atmospheric pressure. It is often desirable for spacers 5 to be sufficiently small so that they are visibly unobtrusive. Once the space between the substrates 2, 3 has been evacuated, the tube may be sealed, e.g., by melting.

The tube 8 oftentimes is located in the corner of one of the substrates, e.g., as shown in FIGS. 1-2. The tube 8 may be made of glass and protrude above the surface of the substrate in which it is located, e.g., to facilitate melting. Because the tube it glass, it frequently can be quite fragile. Furthermore, because the glass tube extends above the outer surface of the substrate, it oftentimes is susceptible to damage. To address these and/or other fragility problems, protective caps sometimes have been placed over the tubes.

In some cases, protective caps have been adhered to the pump-out port by silicone adhesives. Unfortunately, however, this technique has several drawbacks. For example, this approach provides a mechanical bond between the cap and the pump-out tube. The mechanical bonding between the cap and the pump-out tube, however, makes the tube susceptible to damage as a result of external mechanical manipulation of the cap (e.g., as a result of applied pressure, bumping, thermal expansion, etc.). Thus, although the cap is supposed to be protective, it can jostle and sometimes even break the tube. If the tube is broken, then vacuum will be lost and the VIG unit will be rendered largely inoperative for its intended purposes.

Another drawback relates to the limited lifetime of silicone-based adhesives. Indeed, silicone adhesives typically have an anticipated lifetime that is shorter than that of a VIG unit. Thus, the silicone could fail after time as a result of its normal product lifecycle. In such cases, the cap may come off, leaving the pump-out tube largely unprotected.

Still another drawback relates to the difficulty in applying silicon sealants. Silicone sealants oftentimes are “messy,” leading to potentially difficult or irritating and costly cleanup processes.

Thus, it will be appreciated that there is a need in the art for improved techniques for protecting the pump-out tubes used in VIG units, and/or VIG units made using such techniques.

One aspect of certain example embodiments relates to providing a cap over a pump-out tube such that the cap and the pump-out tube are mechanical isolated from one another.

Another aspect of certain example embodiments relates to securing the cap to an outer major surface of a substrate of the VIG unit via an adhesive (e.g., a double-sided tape or other adhesive).

In certain example embodiments of this invention, a vacuum insulating glass (VIG) unit is provided. First and second substantially parallel spaced apart substrates at least partially define a cavity therebetween, with the cavity being at a pressure less than atmospheric. A plurality of support pillars is interposed between the first and second substrates. A peripheral edge seal is formed. A pump-out tube includes a portion that protrudes outwardly from an outer surface of the VIG unit. A cap is disposed over the outwardly protruding portion of the pump-out tube, with the cap being connected to the outer surface of the VIG unit from which the outwardly protruding portion of the pump-out tube protrudes. The cap and the pump-out tube are mechanically isolated from one another.

In certain example embodiments of this invention, a vacuum insulating glass (VIG) unit is provided. First and second substantially parallel spaced apart glass substrates at least partially define a cavity therebetween, with the cavity being evacuated to a pressure less than atmospheric. A plurality of support pillars is interposed between the first and second substrates. An edge seal is located around a periphery of the first and second substrates. A glass pump-out tube includes a sealed portion that protrudes outwardly from an outer surface of the first substrate. A cap is disposed over the sealed portion of the pump-out tube, with the cap including a dome-shaped upper portion forming a recess for receiving the sealed portion of the pump-out tube, and a generally flat base portion for facilitating a connection between the cap and the outer surface of the first substrate.

In certain example embodiments of this invention, a method of making a vacuum insulating glass (VIG) unit is provided. A first substrate is provided. A plurality of pillars is disposed on the first substrate. A second substrate is provided substantially parallel to and spaced apart from the first substrate so as to at least partially define a cavity between the first and second substrates. An edge seal is formed at a periphery of the first and/or second substrates (e.g., by applying a solder glass or other frit, and optionally firing and/or drying it). The cavity is evacuated to a pressure less than atmospheric through a pump-out tube located in either the first or second substrate. The pump-out tube is sealed. A cap is disposed over an outwardly protruding portion of the pump-out tube, with the cap being connected to the outer surface of the substrate from which the outwardly protruding portion of the pump-out tube protrudes. The cap and the pump-out tube are mechanically isolated from one another.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a prior art cross-sectional view of a conventional vacuum IG unit;

FIG. 2 is a prior art top plan view of the bottom substrate, edge seal, and spacers of the FIG. 1 vacuum IG unit taken along the section line illustrated in FIG. 1;

FIG. 3 is a cross-sectional view of a vacuum insulating glass unit according to certain example embodiments;

FIG. 4 is a bottom plan view of a pump-out cap that may be used in accordance with the VIG units of certain example embodiments; and

FIG. 5 is a flowchart showing an illustrative process for making a VIG unit in accordance with certain example embodiments.

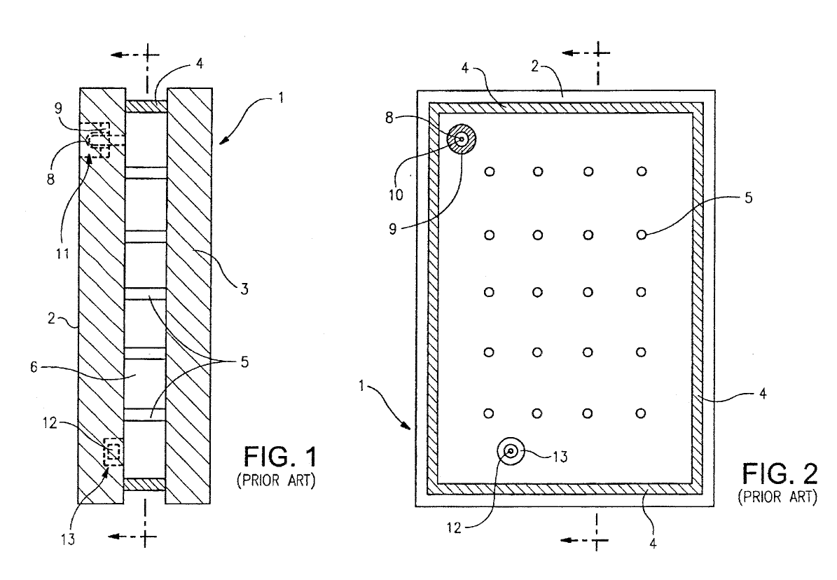

### DETAILED DESCRIPTION OF EXAMPLE EMBODIMENTS OF THE INVENTION

Certain embodiments of this invention relate to an improved peripheral or edge seal in a vacuum IG window unit, and/or a method of making the same. “Peripheral” and “edge” seals herein do not mean that the seals are located at the absolute periphery or edge of the unit, but instead mean that the seal is at least partially located at or near (e.g., within about two inches) an edge of at least one substrate of the unit. Likewise, “edge” as used herein is not limited to the absolute edge of a glass substrate but also may include an area at or near (e.g., within about two inches) of an absolute edge of the substrate(s). Also, it will be appreciated that as used herein the term “VIG assembly” refers to an intermediate product prior to the VIG's edges being sealed and evacuation of the recess including, for example, two parallel-spaced apart substrates and a frit. Also, while the frit may be said to be “on” or “supported” by one or more of the substrates herein, this does not mean that the frit must directly contact the substrate(s). In other words, the word “on” covers both directly and indirectly on, so that the frit may be considered “on” a substrate even if other material (e.g., a coating and/or thin film) is provided between the substrate and the frit.

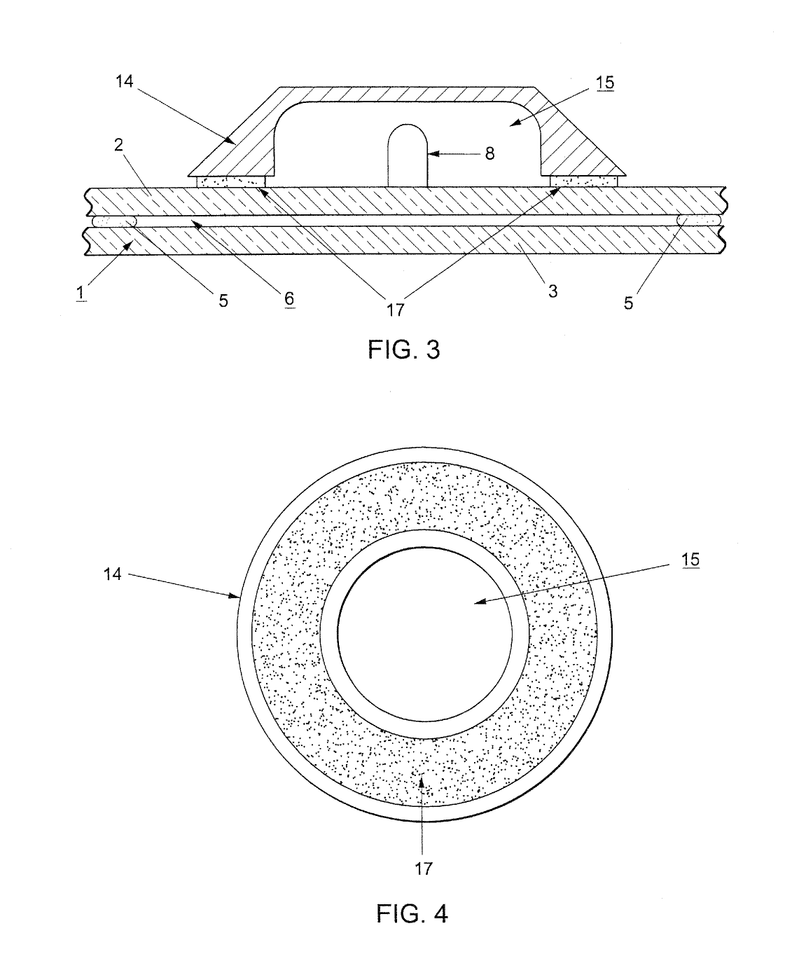

Referring now more particularly to the drawings, FIG. 3 is a cross-sectional view of a vacuum insulating glass unit according to certain example embodiments, and FIG. 4 is a bottom plan view of a pump-out cap that may be used in accordance with the VIG units of certain example embodiments. As shown in FIG. 3, the pump-out tube 8 protrudes outwardly from the outer face of the substrate 2. However, it is at least partially surrounded by a protective cap 14. The protective cap 14 is connected (e.g., adhered) to the outer surface of the substrate 2 and does not come into direct or even indirect mechanical contact with the tube 8. Instead, a cavity 15 around the tube 8 and enclosed by the cap 14 is formed by virtue of the curved cross-sectional shape of the cap 14.

Thus, the cap design includes a cavity helps that mechanically separate the cap 14 from the pump-out tube 8. In certain example embodiments, the button surface of the cap 14 is connected to the outer surface of the substrate 2 through the use of only high-strength double-sided tape or adhesive 17. An example double-sided tape or adhesive that may be used in connection with certain example embodiments is 3M's VHB (Very High Bond) commercially available product. Of course, it will be appreciated that other double-sided tapes and/or adhesives may be used in different embodiments of this invention.

It will be appreciated that the bottom surface of the cap may be substantially flat to accommodate the adhesive and mate well with the outer surface of the substrate in which the tube is located. In certain example embodiments, the adhesive material may be sized so that it is slightly smaller than the flat base of the cap, e.g., to allow for some small amount of misregistration in mounting. In certain example embodiments, lips may be formed in the inner and/or outer areas of the cap, thereby defining a channel, recess, or other area in which the adhesive may be located.

The example approach shown in FIGS. 3-4 is advantageous for a number of reasons. One advantage relates to the mechanical isolation between the cap and the pump-out tube. By mechanically connecting the cap to the tube (e.g., using silicone), the mechanical bond between the cap and the pump-out tube is made susceptible to mechanical manipulation and damage as a result of bumping, direct pressure, thermal expansion, removal, etc. If the pump-out tube is broken or cracked, vacuum is lost and the VIG rendered useless for its intended purposes. By contrast, the mechanical separation between the cap and the tube offered by certain example embodiments sometimes allows for the cap to be bumped, manipulated, removed, etc., without having such pressures directly transferred to the more fragile tube located axially therein.

3M's VHB and other similar adhesives are designed to last 20 to 30 years in application, which matches well with the anticipated lifetime of a VIG unit. Suitable adhesives are used in automotive applications, for example, sometimes helping to hold emblems and body cladding. Such materials have proven themselves in automotive applications as being able to maintain their bonds and also as being resistant (and sometimes even impervious) to UV degradation over the life of a vehicle. These types of adhesives are also utilized and proven in the fenestration industry to adhere simulated divided lite (SDL) grids to windows.

3M's VHB and other similar adhesives may be die-cut into the desired or appropriate shapes for application onto the cap and/or a VIG unit or VIG unit subassembly. The die-cut adhesives may also be provided on tape-reels, facilitating automated assembly in certain example embodiments. This technique may be used to improve the manufacturing process and increase the chance of quality application, e.g., by providing proper sizing and shaping of the adhesive material, quality registration as between the adhesive, the cap, and the VIG unit, etc.

Moreover, in certain example productions, cleanup and waste associated with typical silicone application may be reduced or even completely eliminated by simply providing a well-sized adhesive material.

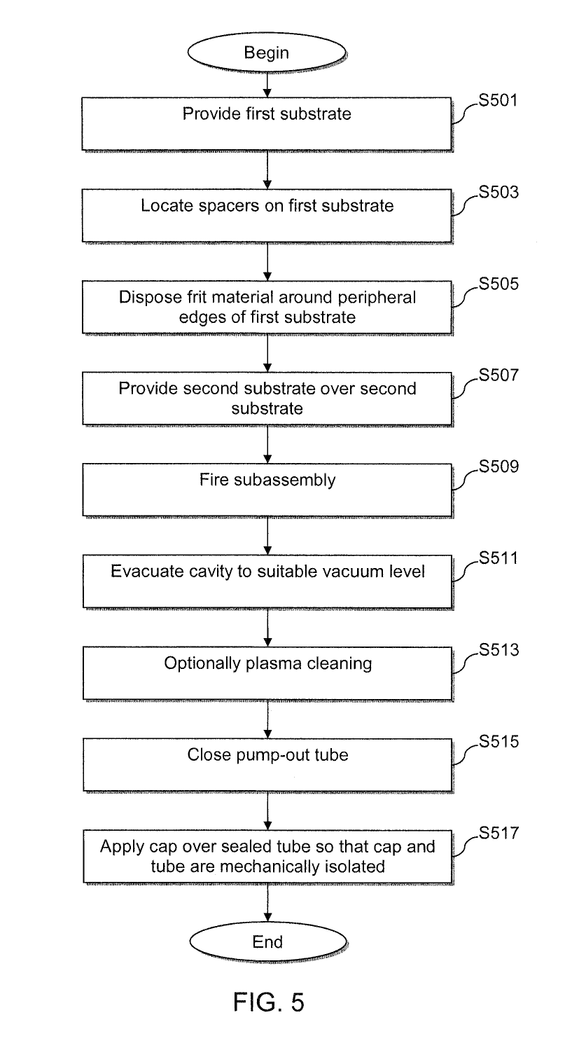

FIG. 5 is a flowchart showing an illustrative process for making a VIG unit in accordance with certain example embodiments. A first substrate is provided in step S501. Spacers or pillars are located on a first major surface of the first substrate in step S503. In step S505, frit material is disposed (e.g., printed or otherwise applied) around peripheral edges of the first substrate. In step S507, the second substrate is provided over the second substrate, sandwiching the pillars or spacers and defining a cavity therebetween. The subassembly is fired in step S509, e.g., to form hermetic edge seals. The cavity is evacuated to a suitable vacuum level in step S511, e.g., using a pump-out tube disposed in a pump-out port of the first or second substrate, in the edge seal, or elsewhere. Plasma cleaning (e.g., of the space between the first and second substrates) optionally may be performed in step S513. See, for example, U.S. application Ser. No. 13/149,085, filed on May 31, 2011, and U.S. Pat. No. 6,692,600, the entire contents of each of which are hereby incorporated herein by reference.

In step S515, the pump-out tube is closed. This may be accomplished in certain example embodiments by melting a tube, e.g., by focusing a laser beam on it or by exposing to some other form of heat and/or energy. In step S517, a cap may be disposed over the sealed tube so that a cavity of the cap axially accommodates a protruding portion of the tube. The cap preferably is connected to the outer surface of the substrate or area where the tube is located so that the cap and the tube are mechanically isolated from one another. This bonding may be accomplished using an adhesive (which may in certain example embodiments be a double-sided tape or other adhesive) that is interposed between a flat bottom surface of the cap and the substrate's surface. The adhesive material preferably will be projected to last the lifetime of the VIG unit, may be resistant to UV, water, etc., and may form a high-quality seal between the cap and the substrate.

The cap of certain example embodiments may be made of metal, plastic, silicone, or some other suitable material. In certain example embodiments, the coefficients of thermal expansion for the cap and the glass substrate may match one another preferably within about 25%, more preferably within about 20%, and sometimes within about 10-20%.

FIGS. 3 and 4 show example profiles for the cap. However, other profiles may be used in different example embodiments. For instance, the cap need not be substantially circular shaped when viewed from its bottom. The cap may in certain example embodiments be substantially square-shaped when viewed from its bottom. In certain example embodiments, the cap may have a different outward appearance, e.g., for aesthetic purposes. For example, it may be stamped or punched to include with a manufacturer's logo in certain instances. In other example embodiments, the “side legs” shown in FIG. 3 may be angled to a greater or lesser degree, e.g., so as to reduce the profile of the cap.

The cap may have an inner recess with a diameter or distance and height sufficient to accommodate the pump-out tube and also help ensure mechanical separation therewith. The surface area of the base portion of the cap may be sufficient to accommodate the adhesive and help ensure a good connection between the cap and the surface on which it is mounted. In certain example embodiments, the diameter or distance of the recess in the cap may be 2-20 mm, more preferably 3-15 mm, and still more preferably 5-10 mm. An example diameter or distance of the recess for the cap is 8.75 mm. In certain example embodiments, the outermost diameter or distance may be 3-30 mm, more preferably 7-25 mm, and still more preferably 10-20 mm. An example diameter or distance of the outermost diameter or distance is 15 mm. The cross-sectional width of the foot portion may be about 0.5-6 mm, more preferably 2-5 mm, and still more preferably 3-4 mm. An example cross-sectional width of the foot portion is 3.125 mm. An example height for the uppermost portion of the cavity is 2.75 mm. Preferably, the uppermost portion of the cavity will be at least about 0.25 mm above the uppermost portion of the pump-out tube, more preferably at least about 0.5-1.25 mm above the uppermost portion of the pump-out tube. It has been found that the example dimensions for the inner diameter of the recess and the height help ensure adequate mechanical isolation and that the example cross-sectional width of the foot portions helps provide a good and lasting bond. Of course, other dimensions and/or shapes may be used in different embodiments.

Moreover, although more space is shown between the edges of the tubes and the inner surface of the cap as compared to the distance between the top of the tube and the bottom of the cap, other example embodiments may use different configurations. In certain example embodiments, the cap may have an inner diameter or cavity distance of less than 1 cm. The tube may have a diameter or distance from 0.1 to 1 mm, more preferably about 0.3-0.7 mm, and sometimes about 0.5 mm. The cap may be located relative to the tube such that the tube is substantially centered within the cavity of the cap.

Edge seal 4 may be made of any suitable material, including but not limited to solder glass in different embodiments of this invention. In certain embodiments, edge seal 4 may be cured using microwave energy, infrared radiation, or any other suitable heat source. In certain example embodiments, the frit material used to seal the edges of the VIG unit may be, for example, one of the frit materials disclosed in application Ser. No. 12/929,875, filed Feb. 22, 2011; and/or application Ser. No. 13/238,358, filed Sep. 21, 2011, the entire contents of each of which are incorporated herein by reference. Other frit materials may be used including, for example, Ferro 2824B and 2824G fits. See, for example, application Ser. No. 12/929,874, filed Feb. 22, 2011, the entire contents of which are incorporated herein by reference. Other so-called “lead-free” frits may be used in different embodiments.

Sealing temperatures may be less or equal to about 500 degrees C. in certain example embodiments. Preferably, sealing temperatures may be kept still lower, e.g., less than or equal to about 450 degrees C., more preferably less than or equal to about 400 degrees C., and sometimes less than or equal to around 375 degrees C. An example fit sealing temperature used in connection with the fits listed above is about 380 degrees C.

In certain embodiments, each spacer 5 may have a height of from about 0.1 to 1.0 mm, more preferably from about 0.2 to 0.4 mm. Spacers 5 may be made of solder glass, glass, ceramic, metal, polymer, or any other suitable material in different embodiments of this invention. Spacers 5 may be cylindrical in shape, round in shape, spherical in shape, dime-shaped, C-shaped, pillow-shaped, or any other suitable shape in different embodiments of this invention.

In certain embodiments of this invention, substrates 2 and 3 may be approximately the same size. However, in other embodiments, one glass substrate 2 may be larger in size than the other glass substrate 3 in order to provide an approximately L-shaped step proximate an edge of the vacuum IG unit.

It will be appreciated that the example embodiments described herein may be used in connection with a variety of different VIG assembly and/or other units or components. For example, the substrates may be glass substrates, heat strengthened substrates, tempered substrates, etc.

In certain example embodiments of this invention, a vacuum insulating glass (VIG) unit is provided. First and second substantially parallel spaced apart substrates at least partially define a cavity therebetween, with the cavity being at a pressure less than atmospheric. A plurality of support pillars is interposed between the first and second substrates. A peripheral edge seal is formed. A pump-out tube includes a portion that protrudes outwardly from an outer surface of the VIG unit. A cap is disposed over the outwardly protruding portion of the pump-out tube, with the cap being connected to the outer surface of the VIG unit from which the outwardly protruding portion of the pump-out tube protrudes. The cap and the pump-out tube are mechanically isolated from one another.

The features of the preceding paragraph may be provided in connection with example embodiments in which the outer surface of the VIG unit from which the outwardly protruding portion of the pump-out tube protrudes is a major surface of the first substrate.

The features of the preceding paragraph may be provided in connection with example embodiments that further comprise an adhesive connecting the cap to the major surface of the first substrate.

The features of the preceding paragraph may be provided in connection with example embodiments in which the adhesive (e.g., a double-sided tape or other adhesive) connects the cap only to the major surface of the first substrate.

The features of any one of the preceding four paragraphs may be provided in connection with example embodiments in which the cap includes a dome-shaped upper portion forming a recess for accommodating the outwardly protruding portion of the pump-out tube.

The features of the preceding paragraph may be provided in connection with example embodiments in which the cap further includes a generally flat base portion for facilitating the connection between the cap and the outer surface of the VIG unit.

The features of the preceding paragraph may be provided in connection with example embodiments in which a double-sided tape or adhesive is disposed between the base portion of the cap and the outer surface of the VIG unit.

The features of the preceding paragraph may be provided in connection with example embodiments in which the top and sides of the pump-out tube are spaced apart from bottom and inner sidewall portions of the cap.

The features of any one of the eight preceding paragraphs may be provided in connection with example embodiments in which the pump-out tube is made of glass and/or the substrates are glass substrates.

In certain example embodiments of this invention, a vacuum insulating glass (VIG) unit is provided. First and second substantially parallel spaced apart glass substrates at least partially define a cavity therebetween, with the cavity being evacuated to a pressure less than atmospheric. A plurality of support pillars is interposed between the first and second substrates. An edge seal is located around a periphery of the first and second substrates. A glass pump-out tube includes a sealed portion that protrudes outwardly from an outer surface of the first substrate. A cap is disposed over the sealed portion of the pump-out tube, with the cap including a dome-shaped upper portion forming a recess for receiving the sealed portion of the pump-out tube, and a generally flat base portion for facilitating a connection between the cap and the outer surface of the first substrate.

The features of the preceding paragraph may be provided in connection with example embodiments in which the cap and the pump-out tube are mechanically isolated from one another.

The features of the preceding paragraph may be provided in connection with example embodiments in which a double-sided tape or adhesive is disposed between the base portion of the cap and the outer surface of the first substrate.

In certain example embodiments of this invention, a method of making a vacuum insulating glass (VIG) unit is provided. A first substrate is provided. A plurality of pillars is disposed on the first substrate. A second substrate is provided substantially parallel to and spaced apart from the first substrate so as to at least partially define a cavity between the first and second substrates. An edge seal is formed at a periphery of the first and/or second substrates (e.g., by applying a solder glass or other fit, and optionally firing and/or drying it). The cavity is evacuated to a pressure less than atmospheric through a pump-out tube located in either the first or second substrate. The pump-out tube is sealed. A cap is disposed over an outwardly protruding portion of the pump-out tube, with the cap being connected to the outer surface of the substrate from which the outwardly protruding portion of the pump-out tube protrudes. The cap and the pump-out tube are mechanically isolated from one another.

The features of the preceding paragraph may be provided in connection with example embodiments in which the cap is connected to the outer surface of the substrate from which the outwardly protruding portion of the pump-out tube protrudes via an adhesive.

The features of any one of the two preceding paragraphs may be provided in connection with example embodiments in which the cap includes a dome-shaped upper portion forming a recess for accommodating the outwardly protruding portion of the pump-out tube.

The features of the preceding paragraph may be provided in connection with example embodiments in which the cap further includes a generally flat base portion for facilitating a connection between the cap and the outer surface of the substrate from which the outwardly protruding portion of the pump-out tube protrudes.

The features of the preceding paragraph may be provided in connection with example embodiments in which the double-sided tape or adhesive is disposed between the base portion of the cap and the outer surface of the VIG unit.

The features of any one of the five preceding paragraphs may be provided in connection with example embodiments in which the top and sides of the pump-out tube are spaced apart from bottom and inner sidewall portions of the cap.

The features of any one of the six preceding paragraphs may be provided in connection with example embodiments that further include cleaning the cavity using at least one plasma.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A vacuum insulating glass (VIG) unit, comprising:
first and second substantially parallel spaced apart substrates at least partially defining a cavity therebetween, the cavity being at a pressure less than atmospheric;
a plurality of support pillars interposed between the first and second substrates;
a peripheral edge seal;
a pump-out tube including a portion that protrudes outwardly from an outer surface of the VIG unit; and
a cap disposed over the outwardly protruding portion of the pump-out tube, the cap being connected to the outer surface of the VIG unit from which the outwardly protruding portion of the pump-out tube protrudes,
wherein the cap and the pump-out tube are mechanically isolated from one another.

2. The VIG unit of claim 1, wherein the outer surface of the VIG unit from which the outwardly protruding portion of the pump-out tube protrudes is a major surface of the first substrate.

3. The VIG unit of claim 2, further comprising an adhesive connecting the cap to the major surface of the first substrate.

4. The VIG unit of claim 3, wherein the adhesive connects the cap only to the major surface of the first substrate.

5. The VIG unit of claim 4, wherein the adhesive is a double-sided tape.

6. The VIG unit of claim 1, wherein the cap includes a dome-shaped upper portion forming a recess for accommodating the outwardly protruding portion of the pump-out tube.

7. The VIG unit of claim 6, wherein the cap further includes a generally flat base portion for facilitating the connection between the cap and the outer surface of the VIG unit.

8. The VIG unit of claim 7, wherein a double-sided tape or adhesive is disposed between the base portion of the cap and the outer surface of the VIG unit.

9. The VIG unit of claim 8, wherein the top and sides of the pump-out tube are spaced apart from bottom and inner sidewall portions of the cap.

10. The VIG unit of claim 1, wherein the pump-out tube is made of glass.

11. A vacuum insulating glass (VIG) unit, comprising:
first and second substantially parallel spaced apart glass substrates at least partially defining a cavity therebetween, the cavity being evacuated to a pressure less than atmospheric;
a plurality of support pillars interposed between the first and second substrates;
an edge seal located around a periphery of the first and second substrates;
a glass pump-out tube including a sealed portion that protrudes outwardly from an outer surface of the first substrate; and
a cap disposed over the sealed portion of the pump-out tube, the cap including a dome-shaped upper portion forming a recess for receiving the sealed portion of the pump-out tube, and a generally flat base portion for facilitating a connection between the cap and the outer surface of the first substrate.

12. The VIG unit of claim 11, wherein the cap and the pump-out tube are mechanically isolated from one another.

13. The VIG unit of claim 12, wherein a double-sided tape or adhesive is disposed between the base portion of the cap and the outer surface of the first substrate.

14. A method of making a vacuum insulating glass (VIG) unit, the method comprising:
providing a first substrate;
disposing a plurality of pillars on the first substrate;
providing a second substrate substantially parallel to and spaced apart from the first substrate so as to at least partially define a cavity between the first and second substrates;
forming an edge seal at a periphery of the first and/or second substrates;
evacuating the cavity to a pressure less than atmospheric through a pump-out tube located in either the first or second substrate;
sealing the pump-out tube;
disposing a cap over an outwardly protruding portion of the pump-out tube, the cap being connected to the outer surface of the substrate from which the outwardly protruding portion of the pump-out tube protrudes,
wherein the cap and the pump-out tube are mechanically isolated from one another.

15. The method of claim 14, wherein the cap is connected to the outer surface of the substrate from which the outwardly protruding portion of the pump-out tube protrudes via an adhesive.

16. The method of claim 14, wherein the cap includes a dome-shaped upper portion forming a recess for accommodating the outwardly protruding portion of the pump-out tube.

17. The method of claim 16, wherein the cap further includes a generally flat base portion for facilitating a connection between the cap and the outer surface of the substrate from which the outwardly protruding portion of the pump-out tube protrudes.

18. The method of claim 17, wherein a double-sided tape or adhesive is disposed between the base portion of the cap and the outer surface of the VIG unit.

19. The method of claim 14, wherein the top and sides of the pump-out tube are spaced apart from bottom and inner sidewall portions of the cap.

20. The method of claim 14, further comprising cleaning the cavity using at least one plasma.
